(19) United States
(12) Patent Application Publication
(10) Pub. No.: US 2006/0230155 A1
(43) Pub. Date: Oct. 12, 2006

(54) System and method for peer-to-peer communications with soft hand over for internet enabled devices

(76) Inventor: Amit Kumar Verma, Flower Mound, TX (US)

Correspondence Address: AMIT KUMAR VERMA, 1717 DALTON DRIVE, FLOWER MOUND, TX, 75022, US

(21) Appl. No.: 11/375,219

(22) Filed: Mar. 14, 2006

Related U.S. Application Data
(60) Provisional application No. 60/662,092, filed on Mar. 15, 2005.

(51) Int. Cl. G06F 15/16

(52) U.S. Cl. 709/227

(57) ABSTRACT

An improved system and method are disclosed for peer-to-peer communications with soft hand over for Internet enabled devices.

The present application claims benefits of U.S. provisional patent Ser No. 60/662,092 filed Mar. 15^{th} 2005 which is hereby incorporated by reference

An improved system and method are disclosed for peer-to-peer communications with soft hand over for Internet enabled devices.

### BACKGROUND

Current peer-to-peer networks support communication between various endpoints with or without the use of an intermediary device (e.g., a host or server). Peer-to-peer networks generally require a user to build a “buddy list” to store information regarding other endpoints in the system with whom an endpoint has permission to communicate. This buddy list approach solves the problem of identifying other endpoints but it provides users an inefficient and unconventional mechanism of communication. Current Peer-to-peer networks do not provide for a mechanism to seamlessly migrate to alternate networks.

Therefore, what is needed is a system and method that addresses these issues.

### BRIEF DESCRIPTION OF THE DRAWINGS

FIG. 1 is a high-level network diagram of one embodiment of a peer-to-peer system of communications with soft hand over for internet enabled devices.

FIG. 2 is a sequence diagram illustrating an exemplary process by which an endpoint of FIG. 1 registers and activates one embodiment of a peer-to-peer system of communications with soft hand over for internet enabled devices.

FIG. 3 is a sequence diagram illustrating an exemplary process by which an endpoint of FIG. 1 communicates with another endpoint of FIG. 1.

### DETAILED DESCRIPTION

The present disclosure is directed to a system and method for peer-to-peer system of communications with soft hand over for internet enabled devices. The present disclosure provides many different embodiments or examples. These examples of components and arrangements are outlined below to simplify the present disclosure. However, these are, of course, merely examples and are not intended to be limiting. Numerals and/or letters in the present disclosure may be repeated in the various examples. The purpose of this repetition is to simplify and clarify, but not to dictate in itself a relationship between the various embodiments and/or configurations discussed.

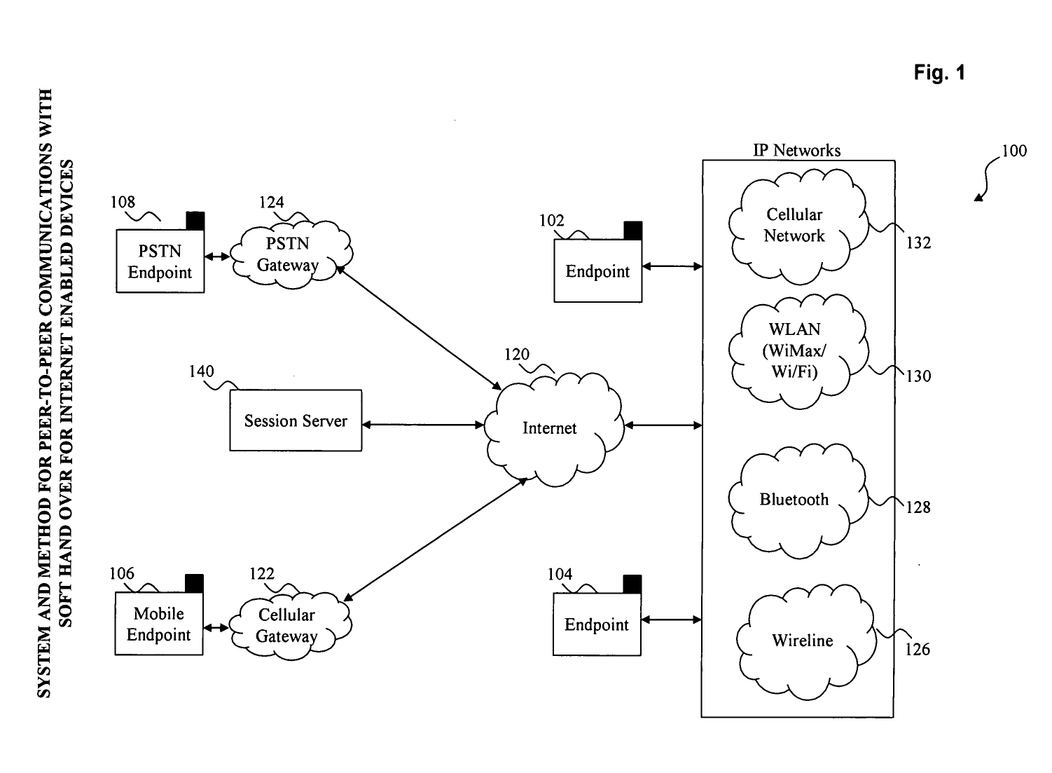

Referring to FIG. 1, one embodiment of a peer-to-peer system with soft hand over for Internet enabled devices 100 is illustrated. The system 100 includes an endpoint 102 that is coupled to endpoint 104 via IP Networks 126, 128, 130, 132; an endpoint 106 that is coupled to the system via cellular gateway 122; an endpoint 108 coupled to the system via PSTN gateway 124. Communication between the session server 140 and endpoints 102, 104, 106, 108 is accomplished using predefined communication standards or protocols. An example of predefined communication protocol is Session Initiation Protocol (SIP) for signaling (e.g., session setup, management, and teardown) Real-time Transport Protocol (RTP) for media. The communications may include, but are not limited to, audio, video, instant messages, data files, emails, and any other type of digital data transfer.

Connections between the session server 140, and endpoints 102, 104 may include wireline and/or wireless communication channels. In the following description, it is understood that the term “direct” means that there is no endpoint or session server in the communication channel(s) between the endpoints 102, 104 or between endpoint and the session server. Accordingly, the session server 140 and endpoints 102, 104 are directly connected even if other devices (e.g., firewalls, routers) are positioned between them. Furthermore, communication between endpoints and services provided by session server or endpoints may be subscription based. Additionally, the following description may use the terms “user” and “endpoint” interchangeably, although it is understood that a user may be using any of a plurality of endpoints. Accordingly, if an endpoint signs in to the network, it is understood that the user is signing in via the endpoint and that the endpoint represents the user on the network using the user's identity.

The session server 140 stores profile information and configuration data for a user, a session table to track what users are currently online, and a route that matches the address of an endpoint to each online user and capabilities associated with an endpoint. The session server 140 is used to retrieve the configuration data that includes routing address and capabilities to each of the endpoints 102, 104 so that the endpoints can communicate directly with one another. Accordingly, in the present embodiment, one function of the session server 140 is to serve as a storage location for information needed by an endpoint in order to communicate with other endpoints. In another embodiment, a function of the session server 140 is to act as a redirect server to facilitate communication between endpoints 102 and 104. Another function of the session server is to act as a SIP proxy server to facilitate communication between endpoints 106, 108 and endpoints 102, 104.

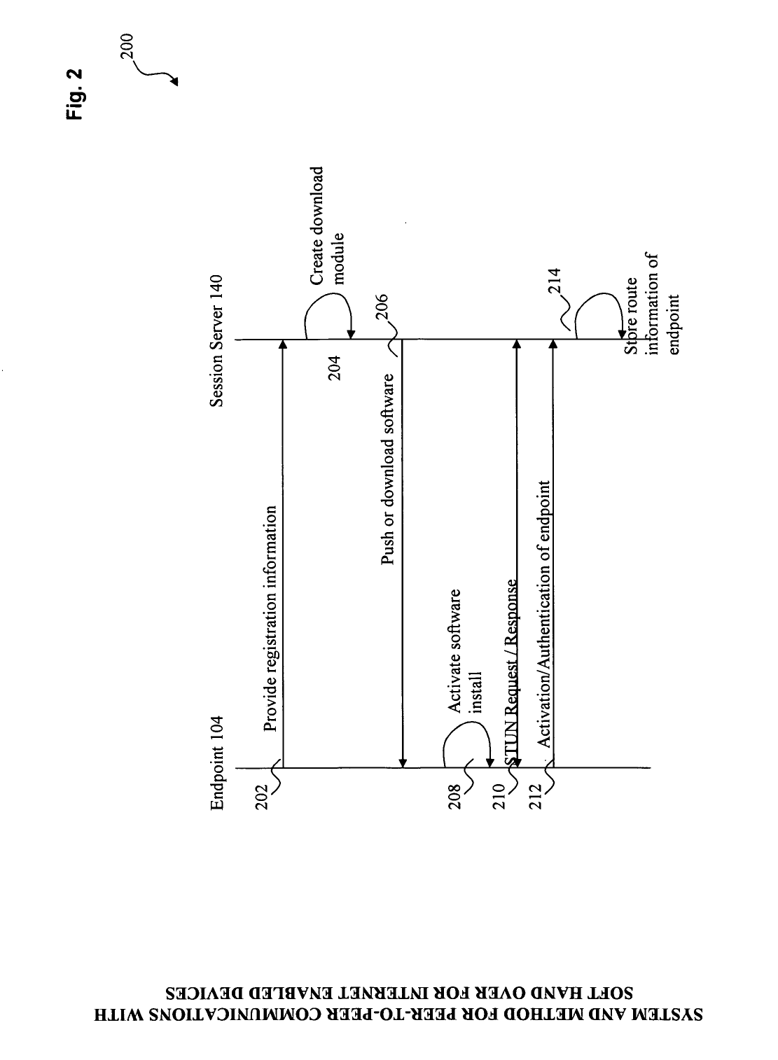

Referring to FIG. 2 (and using the endpoint 104 as an example), a sequence diagram 400 illustrates an exemplary process by which the endpoint 104 may register with the session server 140 and then download endpoint engine software module (not shown in figure) upon successful registration. An endpoint can be registered with different capabilities some of which can be subscription based. Upon successful installation the endpoint will contact session server 140 to activate and authenticate 212, endpoint's online status to be available for communication. One of the steps in the present sequence of events is to send a STUN request to augment the endpoints capabilities stored in the session server 140. In the present example, it is understood that no endpoint is registered or activated at the beginning of the sequence.

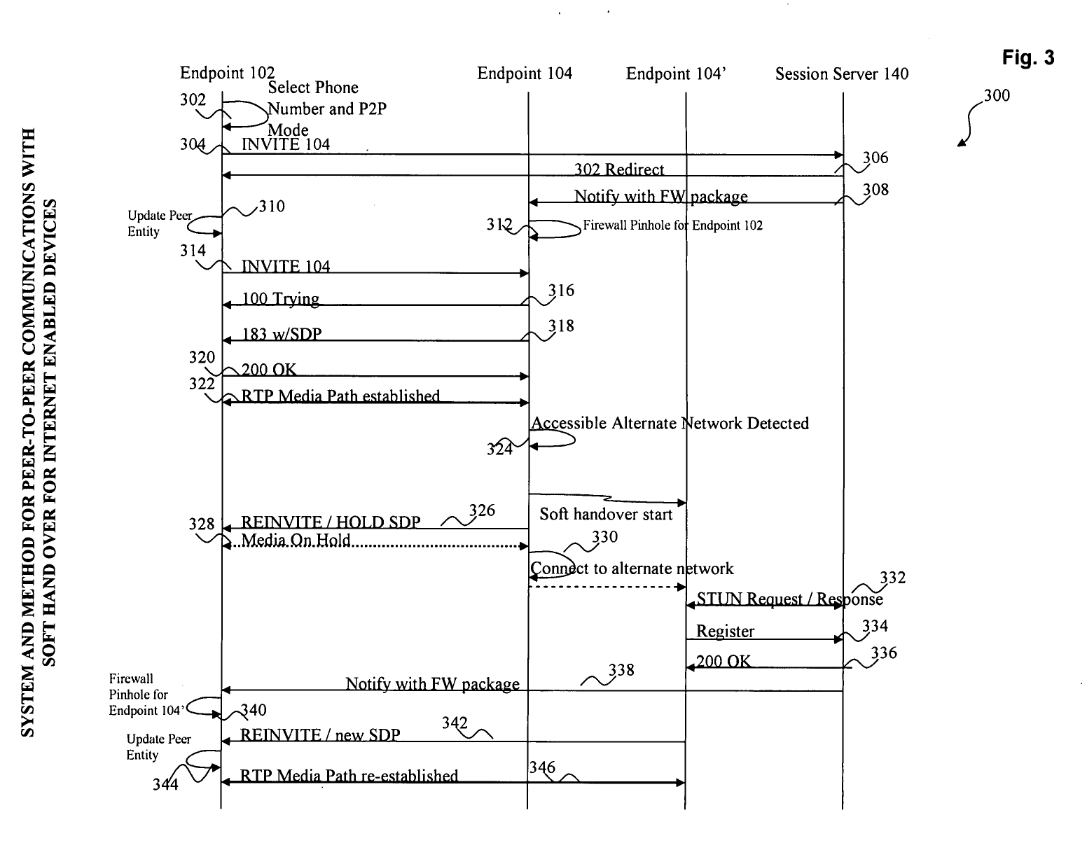

Referring to FIG. 3, a sequence diagram 300 illustrates an exemplary process by which endpoint 102 may establish a communication channel with endpoint 104. In step 302, the endpoint 102 selects or enters a phone number and the peer-to-peer mode of operation (for example by dialing ## key sequence before dialing the actual phone number or pre-configuring the system to use peer-to-peer mode) to initiate communication with endpoint 104. In step 304 the endpoint 102 sends a request to the session server 140 to locate a route for endpoint 104 (for e.g.; in SIP an INVITE message is sent). In step 306, if endpoint 104 is authenticated and online, the session server 140 sends a response to endpoint 104 with a message that may include, but are not limited to, route information, capabilities etc. (for e.g.; a SIP redirect 302 message is sent requesting endpoint 102 to contact 104). In step 308, the session server sends out a NOTIFY message to endpoint 104 instructing the endpoint with messages indicating that endpoint 102 is requesting a communication channel. This message may include but not limited to instructions to help endpoint 102 to contact endpoint 104, if endpoint 104 is behind a firewall. In step 312, endpoint 104, sends messages to pinhole the firewall to facilitate endpoint 102's messages to get through for establishing a direct communication and media channel. In Step 310 endpoint 102 updates its internal buffers with information of endpoint 104's route information for future operations like setting up a media channel for transmitting data, but not limited to voice, video, data, text. Steps 314-322 are standard SIP messages exchanged between the endpoints 102, 104 to establish a communication channel to exchange media data like voice, video, data and text. It is also understood that the SIP messages are just examples to explain the flow of events or messages and that these messages can be any other protocol or proprietary messaging protocol, to achieve the same behavior of establishing a communication channel.

Referring to FIG. 3, a sequence diagram 300 illustrates an exemplary process by which endpoint 102 may establish a communication channel with endpoint 104 and that endpoint 104 has detected an alternate network. In this scenario, endpoint 104 has detected alternate networks and chooses to migrate to the alternate network for various reasons but not limited to better quality of service, cost issues or higher bandwidth. In step 324, endpoint 104 detects an alternate network and starts the soft hand over process. This process is another embodiment of the present invention to maintain seamless communication channel between endpoints when one or both of them choose to migrate to alternate networks. In step 328, endpoint 104 sends a hold request to hold the current communication channel allowing for endpoint 104 to migrate to the new network. In Step 330 endpoint 104 connects to the alternate network. It is assumed that in this step endpoint 104 has full authority to use the new network with respect to credentials etc. At this step for purposes of explanation that endpoint 104 has migrated to new network, endpoint 104 becomes endpoint 104′. In step 332 a STUN request is send to session server 140 to reestablish endpoint 104′ capabilities. In step 334 a registration command is sent to session server 140 to re-identify endpoint 104s new location or route which is endpoint 104′. In step 338, the session server 140 sends out a NOTIFY message to endpoint 102 instructing the endpoint with messages indicating that endpoint 104′ has changed location and request for re-establishing a new communication channel. This message may include but not limited to instructions to help endpoint 104′ to contact endpoint 102, if endpoint 102 is behind a firewall. In step 340, endpoint 102, sends messages to pinhole the firewall to facilitate endpoint 104 messages to get through for establishing a direct communication and media channel. In Step 344 endpoint 102 updates its internal buffers with information of endpoint 104′ route information for future operations like setting up a media channel for transmitting data, but not limited to voice, video, data, text. In step 342 endpoint 104′ sends out a new message to re-establish the media channel that was on hold during the soft hand over process.

Referring to FIG. 3, though the sequence diagram identifies a scenario of communication between endpoints 102 and 104 of FIG. 1, it is also understood that in another embodiment, that endpoint 102 can be endpoint 106 connected to system 100 via Cellular gateway 122; or endpoint 108 connected to system 100 via PSTN gateway 124.

While the disclosures outlined above describes one or more embodiments, it will be understood by those skilled in the art that various changes in form and detail may be made therein without departing from the spirit and scope of the present disclosure. For example, steps described in one diagram may be incorporated into another diagram. In addition various steps illustrated within a particular sequence diagram may be combined or further divided. It will be also understood that the functionality described above may be provided by hardware and/or software, and may be distributed or combined into a single platform or entity. Furthermore, functionality described in a particular example disclosed may be achieved in a manner different than that illustrated, but is still encompassed within the present disclosure. Hence, the claims are meant to be interpreted in a broad manner and consistent with the spirit of the present disclosure.

What is claimed is:

1. A software and/or hardware-implemented method for establishing and maintaining a communication session between first and second endpoint in a peer-to-peer network, the method comprising:
use of phone number to identify an endpoint; and
not requiring a buddy list for communication; and
endpoint registering its phone number and capabilities on registration; and
endpoint publishing the endpoint route on activation; and
retrieving route and presence information of the second endpoint from a session server using phone number of the registered endpoint; and
mechanism of communicating with registered endpoints that are not part of the address book or phone book or any buddy list provided on the device by user directly providing phone number of the endpoint; and
communication between endpoints may or may not require any intermediary node or processing device.

2. The method of claim 1 further comprising:
sending a request message from the first endpoint to the session server requesting a route for the second endpoint to directly contact the second endpoint for establishing a communication session directly between first and second endpoint; and
establishing the communication session by the first endpoint directly with the second endpoint, wherein all signaling and media traffic messages are sent directly from the first endpoint to the second endpoint and from the second endpoint to the first endpoint.

3. The method of claim 1 further comprising:
sending a request message from the first endpoint directly to the second endpoint using the route information obtained from the session server to request the establishment of a session or call to transmit audio, video or data;
receiving a response message by the first endpoint directly from the session server, wherein the response message indicates that the second endpoint cannot currently accept the request;
switching to alternate networks (e.g. Cellular Network, PSTN, VoiceMail Server) for establishing communication

4. A software and/or hardware-implemented method for establishing and maintaining a relationship between first and second endpoints, the method comprising:
endpoint is identified by phone number; and
Additional data like address book or phone book provided on the device may be used; and
Communication is not dependant on a separate buddy list; and
Phone number is used by the endpoint during registration along with endpoint's capabilities; and
endpoint identifies a route for contact during activation; and
sending a request message from the first endpoint to a session server requesting a route to contact the second endpoint;
determining by the session server whether the second endpoint is online or offline;
receiving the endpoint route by the first endpoint from the session server if the second endpoint is online and when the first endpoint requests communication with second endpoint;

5. A system for peer-to-peer communications, the system comprising:
a session server coupled to a packet-based communications network;
a first endpoint coupled to the session server via the cellular network or wireless network;
a second endpoint coupled to the session server and the first endpoint via the communications network, the ability of the second endpoint to establish a communications channel directly with the first endpoint using endpoint route obtained from the session server, wherein signaling and media traffic communications between the first and second endpoints do not pass through the session server.

7. The system of claim 5 wherein the first and second endpoint utilizes the session initiation protocol (SIP) for signaling and real-time transfer protocol (RTP) for media.

8. The system of claim 5 wherein the session server comprises:
a web services layer configured to provide web services to the first and second endpoints;
an application layer configured to support the web services layer; and
a data access layer configured to store, cache and manage:
at least one routing table identifying endpoint route;
SIP Redirect server to manage peer-to-peer communication
SIP Proxy server to establish peer-to-peer communication
first and second routing tables for the first and second endpoints, respectively, wherein each routing table contains address information needed for the endpoint associated with the routing table to communicate directly with the other endpoints in the endpoint's profile.

9. The system of claim 5 wherein the second endpoint further includes an endpoint engine having:
a call control configured for managing a plurality of services provided by the second endpoint;
a signaling agent, session manager, media manager, security manager layer accessible to the call control and configured for supporting functionality needed to provide the services managed by the call control layer; and
a protocol layer configured to provide a plurality of protocols for supporting the functionality provided by the call control layer and communications with the first endpoint.

10. The system of claim 5 wherein the session server, first endpoint, and second endpoint form a in-network system, and wherein the system further comprises at least one device external to the in-network system.

11. A software and/or hardware-implemented method for establishing a communication soft handover between first and second endpoint in a peer-to-peer network, the method comprising:
an established session between two end-points
one or both endpoint detects presence of an accessible alternate network
existing communication session is reestablished over the alternate network;
when one more endpoints chooses to migrate to the alternate network

12. The method of claim 11 further comprising:
detecting and migrating to an alternate accessible network
sending a re-invite request message from the first endpoint to the session server requesting a route for the second endpoint to directly contact the second endpoint for establishing a communication session directly between first and second endpoint; and establishing the communication session by the first endpoint directly with the second endpoint, wherein all signaling and media traffic messages are sent directly from the first endpoint to the second endpoint and from the second endpoint to the first endpoint.
